(19) United States
(12) Patent Application Publication
(10) Pub. No.: US 2009/0136038 A1
(43) Pub. Date: May 28, 2009

(54) APPARATUS FOR RECEIVING ENCRYPTED DIGITAL DATA AND CRYPTOGRAPHIC KEY STORAGE UNIT THEREOF

(75) Inventor: Kuo-Yang Li, Taipei County (TW)

Correspondence Address: J C PATENTS, INC., 4 VENTURE, SUITE 250, IRVINE, CA, 92618, US

(73) Assignee: EMEMORY TECHNOLOGY INC., Hsin-Chu (TW)

(21) Appl. No.: 11/945,506

(22) Filed: Nov. 27, 2007

(51) Int. Cl. H04L 9/00

(52) U.S. Cl. 380/277

(57) ABSTRACT

An apparatus for receiving encrypted digital data is provided. The apparatus includes a decryption circuit, a controller, an NVM, and a one-way device. The decryption circuit receives a piece of encrypted digital data and decrypts the encrypted digital data into a piece of decrypted digital data. The controller is coupled to the decryption circuit for controlling the flow of the decryption performed by the decryption circuit. The NVM is coupled to the decryption circuit for storing and providing a cryptographic key required in the decryption. The one-way device is coupled between an input bus and the NVM. The one-way device blocks read requests received from the input bus. Besides, the one-way device translates write requests received from the input bus into access signals compatible with the NVM and then outputs the access signals to the NVM.

### BACKGROUND OF THE INVENTION

1. Field of the Invention

The present invention relates to an apparatus for receiving encrypted digital data. More particularly, the present invention relates to a cryptographic key storage unit of the apparatus.

2. Description of the Related Art

High Definition Content Protection (HDCP) is a technology for protecting digital data transmitted through Digital Visual Interface (DVI) or High-Definition Multimedia Interface (HDMI) against unauthorized duplication. The protection is achieved by data encryption and decryption in real time. FIG. 1 shows such an example. The digital versatile disc (DVD) player 101 includes an HDCP transmitter 121 and the television (TV) set 102 includes an HDCP receiver 122. The HDCP transmitter 121 receives digital data read from a DVD, encrypts the data, and then transmits the encrypted digital data to the HDCP receiver 122. The HDCP receiver 122 decrypts the digital data and then the decrypted digital data is displayed on the TV set 102. The encryption and decryption are performed according to private keys. If an unauthorized user tries to record the encrypted digital data output by the DVD player 101 with a recording device 103, the user cannot retrieve the original video stream if this recording device 103 is not an HDCP receiver with the required private key.

An HDCP transmitter or receiver is usually implemented as a system on chip (SoC). The private key is possibly stored in one of two ways. The first way of storage is as shown in FIG. 2. The private key is stored in a non-volatile memory (NVM) 202 outside the SoC 201. When the SoC 201 needs to perform encryption or decryption, the private key is loaded into an embedded random access memory (RAM) 211 of the SoC 201. The NVM 202 is a programmable read-only memory (PROM) or a flash memory. For more detailed examples, please refer to U.S. Patent Publication No. 2002/003878 A1 and U.S. Pat. No. 7,206,943 B2. In this case, the system manufactory may buy the SoC from a chip vendor and buy the private key separately. Since the private key can be programmed into the NVM 202 after the SoC 201 is packaged and sold, the first way of storage is also known as post-programming.

The second way of storage is as shown in FIG. 3. The SoC 301 includes an embedded NVM 302 for storing the private key. The private key is programmed into the NVM 302 before the SoC 301 is packaged and sold. Therefore the second way of storage is also known as pre-programming. In this case, the system manufactory has to buy the private key along with the SoC. For more detailed examples, please refer to the product briefs of Silicon Image Inc. Sil9993 and sil9025 and the product briefs of NXP Inc. TDA998x and TDA997xx.

Both pre-programming and post-programming have drawbacks. Pre-programming requires the customers to buy the private key along with the SoC. In this way the customers lose the freedom of buying private keys from other sources. Although post-programming features flexibility of private key purchase, post-programming imposes a higher cost than pre-programming does. The external NVM 202 imposes extra cost in addition to the cost of the SoC 201. Moreover, for data security, the private key should not be stored in plain data format in an external NVM. The private key has to be encoded and then stored in the NVM 202. Accordingly the SoC 201 has to include a decoder circuit in order to decode the encoded private key. The decoder circuit further imposes extra cost.

### SUMMARY OF THE INVENTION

Accordingly, the present invention is directed to an apparatus for receiving encrypted digital data. This apparatus features both the low cost of pre-programming and the flexibility of post-programming.

The present invention is also directed to a cryptographic key storage unit of the above apparatus. The storage unit includes an embedded NVM, whose fabrication process is compatible with that of a logic circuit, thus featuring easy and low-cost fabrication. The storage unit further includes a one-way device. The one-way device handles write requests directed to the NVM in order to support post-programming of cryptographic keys into the embedded NVM. In addition, the one-way device blocks read requests directed to the NVM in order to achieve data security.

According to an embodiment of the present invention, an apparatus for receiving encrypted digital data is provided. The apparatus includes a decryption circuit, a controller, an NVM, and a one-way device. The decryption circuit receives a piece of encrypted digital data and decrypts the encrypted digital data into a piece of decrypted digital data. The controller is coupled to the decryption circuit for controlling the flow of the decryption performed by the decryption circuit. The NVM is coupled to the decryption circuit for storing and providing a cryptographic key required in the decryption. The one-way device is coupled between an input bus and the NVM. The one-way device blocks read requests received from the input bus. Besides, the one-way device translates write requests received from the input bus into access signals compatible with the NVM and then outputs the access signals to the NVM.

In an embodiment of the present invention, the decryption mentioned above conforms to HDCP and the cryptographic key is a private key.

In an embodiment of the present invention, the NVM is compatible with a logic circuit fabrication process.

According to another embodiment of the present invention, a cryptographic key storage unit of a receiver apparatus is provided. The receiver apparatus receives a piece of encrypted digital data and decrypts the encrypted digital data into a piece of decrypted digital data. The cryptographic key storage unit includes an NVM and a one-way device. The NVM stores and provides a cryptographic key required in the decryption performed by the receiver apparatus. The one-way device is coupled between an input bus and the NVM. The one-way device blocks read requests received from the input bus. In addition, the one-way device translates write requests received from the input bus into access signals compatible with the NVM and then outputs the access signals to the NVM.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a conventional application of HDCP.

FIG. 2 is a schematic diagram showing a conventional post-programming architecture of an HDCP transmitter/receiver.

FIG. 3 is a schematic diagram showing a conventional pre-programming architecture of an HDCP transmitter/receiver.

FIG. 4 is a schematic diagram showing an apparatus for transmitting encrypted digital data according to an embodiment of the present invention.

FIG. 5 is a schematic diagram showing an apparatus for receiving encrypted digital data according to an embodiment of the present invention.

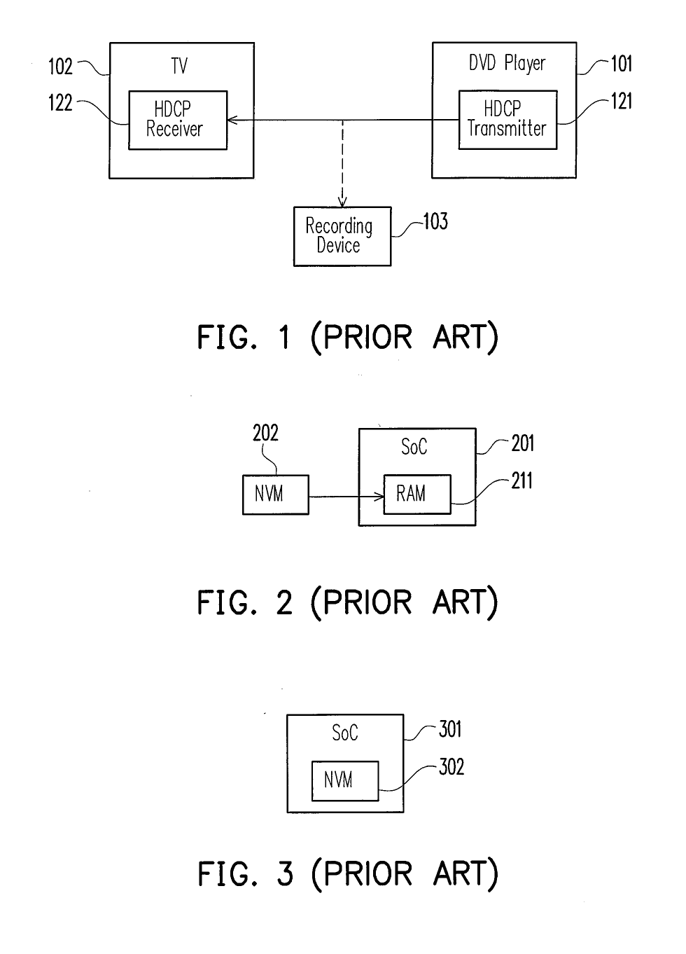

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

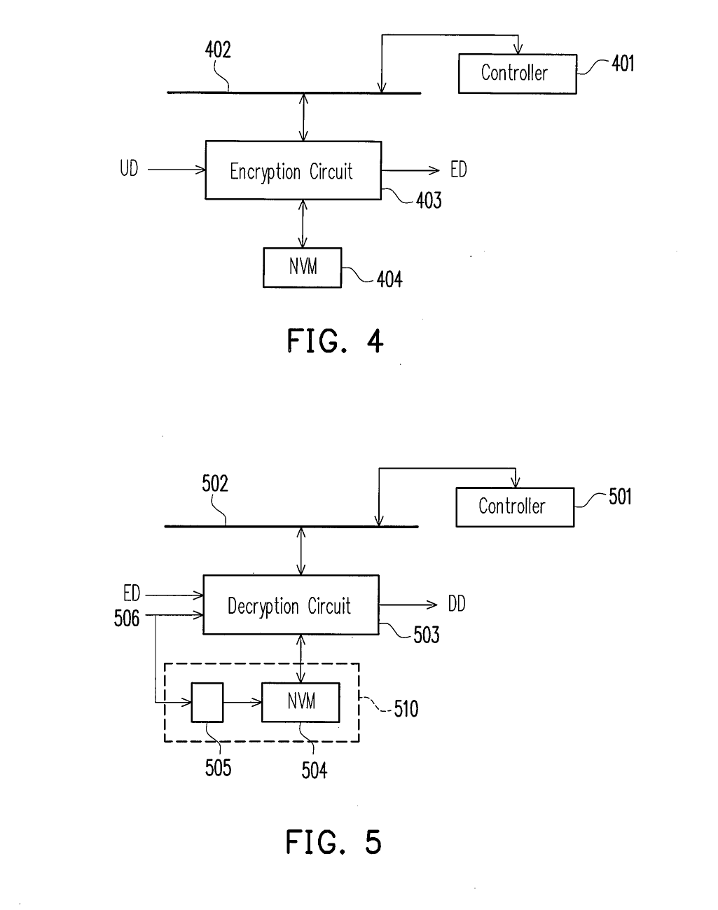

FIG. 4 is a schematic diagram showing an apparatus for transmitting encrypted digital data according to an embodiment of the present invention. This transmitter apparatus includes a controller 401, a control bus 402, an encryption circuit 403, and an NVM 404. The controller 401 is coupled to the encryption circuit 403 through the control bus 402. The NVM 404 is coupled to the encryption circuit 403. The encryption circuit 403 receives the unencrypted digital data UD from a data source and then encrypts the data into the encrypted digital data ED. The controller 401 controls the flow of the encryption performed by the encryption circuit 403. The NVM 404 stores and provides the cryptographic key required in the encryption.

The entire transmitter apparatus shown in FIG. 4 may be fabricated on a single chip. In other words, the transmitter apparatus may be fabricated as an SoC and the NVM 404 may be an embedded NVM of the SoC. The controller 401 and the encryption circuit 403 are logic circuits. The NVM 404 may be designed to be compatible with the fabrication process of the logic circuits 401 and 403. In this way, the NVM 404 needs no extra fabrication masks in addition to those of the logic circuits 401 and 403, thus reducing the cost of the transmitter apparatus.

This transmitter apparatus is applicable to HDCP and any similar technology. The encryption performed by the encryption circuit 403 may conform to HDCP and the cryptographic key stored in the NVM 404 may be an HDCP private key.

FIG. 5 is a schematic diagram showing an apparatus for receiving encrypted digital data according to an embodiment of the present invention. This receiver apparatus includes a controller 501, a control bus 502, a decryption circuit 503, and a cryptographic key storage unit 510. The cryptographic key storage unit 510 includes a one-way device 505 and an NVM 504. The controller 501 is coupled to the decryption circuit 503 through the control bus 502. The NVM 504 is coupled to the decryption circuit 503. The one-way device 505 is coupled between an input bus 506 and the NVM 504. The entire receiver apparatus shown in FIG. 5 may be fabricated on a single chip. In other words, this receiver apparatus may be fabricated as an SoC and the NVM 504 may be an embedded NVM of the SoC.

The decryption circuit 503 receives the encrypted digital data ED from a transmitter apparatus and decrypts the encrypted digital data ED into the decrypted digital data DD. The controller 501 controls the flow of the decryption performed by the decryption circuit 503. The NVM 504 stores and provides the cryptographic key required in the decryption.

The receiver apparatus in FIG. 5 combines the advantages of pre-programming and post-programming. The NVM 504 may be embedded in the SoC and the cryptographic key may be programmed into the embedded NVM 504 before the SoC is packaged and shipped. This supports pre-programming. The architecture of the receiver apparatus in FIG. 5 is an improvement based on the pre-programming architecture shown in FIG. 3. Therefore the cost of the receiver apparatus in FIG. 5 is lower than that of the post-programming architecture shown in FIG. 2.

In addition, the receiver apparatus in FIG. 5 supports post-programming. After the SoC is packaged, the cryptographic key may be programmed into the embedded NVM 504 through the input bus 506 and the one-way device 505. The cryptographic key is delivered by a write request transmitted on the input bus 506. When the one-way device 505 receives the write request from the input bus 506, the one-way device 505 translates the write request into an access signal compatible with the NVM 504 and then outputs the access signal to the NVM 504 in order to program the cryptographic key. In this way the receiver apparatus in FIG. 5 features the same flexibility of key purchase and key programming as the post-programming architecture in FIG. 2 does.

The accessibility of the embedded NVM 504 brings about the problem of the security of the cryptographic key. Therefore the one-way device 505 blocks any read request received from the input bus 506. Consequently the cryptographic key can only be programmed into the embedded NVM 504 but cannot be read from the embedded NVM 504. This achieves data security of the cryptographic key.

The receiver apparatus in FIG. 5 is applicable to HDCP and any similar technology. The decryption performed by the decryption circuit 503 may conform to HDCP and the cryptographic key stored in the NVM 504 may be an HDCP private key.

The input bus 506 may be an Inter-Integrated Circuit (I²C) bus or any other similar interface. If the receiver apparatus in FIG. 5 is fabricated as an SoC, the input bus 506 may be coupled to an I/O pin of the package of the SoC.

The NVM 504 may be an embedded read-only memory (ROM) or an embedded flash memory. If the NVM 504 is an embedded ROM, the NVM 504 may be a one-time programmable (OTP) ROM or a multiple-time programmable (MTP) ROM.

As mentioned above, the entire receiver apparatus shown in FIG. 5 may be fabricated as an SoC and the NVM 504 may be an embedded NVM of the SoC. The controller 501, the decryption circuit 503, and the one-way device 505 are logic circuits. The NVM 504 may be designed to be compatible with the fabrication process of the logic circuits 501, 503, and 505. In this way, the NVM 504 needs no extra fabrication masks in addition to those of the logic circuits 501, 503, and 505, thus reducing the cost of the receiver apparatus.

In summary, the receiver apparatus of the above embodiments features the advantages of both pre-programming and post-programming. The advantages include low cost, data security, and flexibility. The embedded NVM of the receiver apparatus is compatible with logic circuit fabrication process and is highly integrable to logic circuits.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for receiving encrypted digital data, comprising:
a decryption circuit for receiving a piece of encrypted digital data and decrypting the encrypted digital data into a piece of decrypted digital data;
a controller coupled to the decryption circuit for controlling the flow of the decryption performed by the decryption circuit;
a non-volatile memory (NVM) coupled to the decryption circuit for storing and providing a cryptographic key required in the decryption; and
a one-way device coupled between an input bus and the NVM for blocking a read request received from the input bus and translating a write request received from the input bus into an access signal compatible with the NVM and then outputting the access signal to the NVM.

2. The apparatus of claim 1, wherein the decryption conforms to High Definition Content Protection (HDCP).

3. The apparatus of claim 1, wherein the cryptographic key is a private key.

4. The apparatus of claim 1, wherein the apparatus further comprises a control bus and the controller is coupled to the decryption circuit through the control bus.

5. The apparatus of claim 1, wherein the input bus is an Inter-Integrated Circuit (I²C) bus.

6. The apparatus of claim 1, wherein the entire apparatus is fabricated on a single chip.

7. The apparatus of claim 6, wherein the input bus is coupled to an I/O pin of the package of the chip.

8. The apparatus of claim 6, wherein the NVM is an embedded read-only memory (ROM) or an embedded flash memory.

9. The apparatus of claim 8, wherein the NVM is a one-time programmable (OTP) ROM or a multiple-time programmable (MTP) ROM.

10. The apparatus of claim 6, wherein the NVM is compatible with a logic circuit fabrication process.

11. A cryptographic key storage unit of a receiver apparatus, the receiver apparatus receiving a piece of encrypted digital data and decrypting the encrypted digital data into a piece of decrypted digital data, the cryptographic key storage unit comprising:
a non-volatile memory (NVM) for storing and providing a cryptographic key required in the decryption performed by the receiver apparatus; and
a one-way device coupled between an input bus and the NVM for blocking a read request received from the input bus and translating a write request received from the input bus into an access signal compatible with the NVM and then outputting the access signal to the NVM.

12. The cryptographic key storage unit of claim 11, wherein the decryption conforms to High Definition Content Protection (HDCP).

13. The cryptographic key storage unit of claim 11, wherein the cryptographic key is a private key.

14. The cryptographic key storage unit of claim 11, wherein the input bus is an Inter-Integrated Circuit (I²C) bus.

15. The cryptographic key storage unit of claim 11, wherein the receiver apparatus including the cryptographic key storage unit is fabricated on a single chip.

16. The cryptographic key storage unit of claim 15, wherein the input bus is coupled to an I/O pin of the package of the chip.

17. The cryptographic key storage unit of claim 15, wherein the NVM is an embedded read-only memory (ROM) or an embedded flash memory.

18. The cryptographic key storage unit of claim 17, wherein the NVM is a one-time programmable (OTP) ROM or a multiple-time programmable (MTP) ROM.

19. The cryptographic key storage unit of claim 15, wherein the NVM is compatible with a logic circuit fabrication process.
